(19) United States
(12) Patent Application Publication
(10) Pub. No.: US 2022/0001900 A1
(43) Pub. Date: Jan. 6, 2022

(54) DRIVER ABNORMALITY RESPONSE DEVICE, DRIVER ABNORMALITY RESPONSE SYSTEM, AND DRIVER ABNORMALITY RESPONSE METHOD

(71) Applicant: Mitsubishi Electric Corporation, Tokyo (JP)

(72) Inventors: Mitsuo SHIMOTANI, Tokyo (JP); Tadashi MIYAHARA, Tokyo (JP)

(73) Assignee: Mitsubishi Electric Corporation, Tokyo (JP)

(21) Appl. No.: 17/294,310

(22) PCT Filed: Jan. 23, 2019
(86) PCT No.: PCT/JP2019/001974

§ 371 Date: May 14, 2021

(51) Int. Cl. B60W 60/00; B60W 40/09; B60W 50/14; B60W 10/30

(52) U.S. Cl. CPC B60W 60/0059; B60W 40/09; B60W 60/0051; B60W 50/14; B60W 2540/221; B60W 10/30; B60W 60/0015; B60W 2420/42; B60W 60/007

(57) ABSTRACT

It is an object to provide a driver abnormality response device determining, when an abnormality of a driver occurs, whether the driver has an intention to allow a service facility to perform remote operation on a vehicle. The driver abnormality response device includes a driver abnormality acquisition unit and a controller. The driver abnormality acquisition unit acquires an abnormal condition of the driver of the vehicle. Based on the abnormal condition of the driver, the controller performs an intention check sequence to check whether the driver has the intention to allow the service facility capable of performing the remote operation on control of driving of the vehicle to perform the remote operation. Based on a result of the intention check sequence, the controller authorizes the service facility to perform the remote operation.

### TECHNICAL FIELD

The present invention relates to a driver abnormality response device, a driver abnormality response system, and a driver abnormality response method.

### BACKGROUND ART

An emergency call system to respond to a request for rescue has already been constructed in many countries. For example, 119 calls and HELPNET® in Japan, 911 calls in the United States, and eCall in Europe are provided as services of the emergency call system. In such a system, a call center is notified of the occurrence of an abnormal condition when a driver of a vehicle depresses an emergency button provided in the vehicle. An emergency response operator on standby in the call center checks a condition of the driver, and requests deployment of an emergency vehicle. In this case, it is preferable for the driver to stop the vehicle on a roadside by himself/herself. However, it may not be possible for the driver to stop the vehicle, for example, when the driver is in an insane condition. To address such a condition, guidelines have recently been issued concerning a function to automatically stop a vehicle in an emergency.

A support system for rescuing an occupant of a vehicle disclosed in Patent Document 1 controls running of an environment control device of the vehicle in accordance with a remote operation command received from a medical facility based on biological information of the occupant. For example, the support system for rescuing the occupant remotely operates running of the environment control device of the vehicle until a doctor and a rescue team arrive at the vehicle stopping due to a poor health condition of the occupant.

A method for monitoring an occupant of a vehicle disclosed in Patent Document 2 operates an assistance device of the vehicle based on a vital sign of the occupant determined through analysis of an image of the occupant, and autonomously controls the vehicle to the nearest emergency installation.

### PRIOR ART DOCUMENTS

### Patent Documents

Patent Document 1: Japanese Patent Application Laid-Open No. 2016-57673

Patent Document 2: Japanese Patent Application Laid-Open No. 2014-518647

### SUMMARY

### Problem to be Solved by the Invention

When an abnormality of an occupant occurs in a system in which a rescue team rushes to a stopping vehicle, the system dispatches the rescue team to the vehicle without grasping an intention of the occupant. The occupant is thus required to stop the vehicle and wait for rescue regardless of the intention of the occupant.

The present invention has been conceived to solve a problem as described above, and it is an object of the present invention to provide a driver abnormality response device capable of determining, when an abnormality of a driver occurs, whether the driver has an intention to allow a service facility to perform remote operation on control of driving of a vehicle.

### Means to Solve the Problem

A driver abnormality response device according to the present invention includes a driver abnormality acquisition unit and a controller. The driver abnormality acquisition unit acquires an abnormal condition of a driver of a vehicle. Based on the abnormal condition of the driver, the controller performs an intention check sequence to check whether the driver has an intention to allow a service facility capable of performing remote operation on control of driving of the vehicle to perform the remote operation. Based on a result of the intention check sequence, the controller authorizes the service facility to perform the remote operation.

### Effects of the Invention

According to the present invention, the driver abnormality response device capable of determining, when an abnormality of the driver occurs, whether the driver has the intention to allow the service facility to perform the remote operation on the control of driving of the vehicle can be provided.

The objects, features, aspects, and advantages of the present invention will become more apparent from the following detailed description and the accompanying drawings.

### BRIEF DESCRIPTION OF DRAWINGS

FIG. 1 is a block diagram showing a configuration of a driver abnormality response device in Embodiment 1.

FIG. 2 shows one example of a configuration of a processing circuit of the driver abnormality response device.

FIG. 3 shows another example of the configuration of the processing circuit of the driver abnormality response device.

FIG. 4 is a flowchart showing operation of the driver abnormality response device and a driver abnormality response method in Embodiment 1.

FIG. 5 is a block diagram showing configurations of a driver abnormality response device and a driver abnormality response system in Embodiment 2.

FIG. 6 is a flowchart showing operation of the driver abnormality response device in a driver abnormality response method in Embodiment 2.

FIG. 7 is a flowchart showing operation of a service facility in the driver abnormality response method in Embodiment 2.

FIG. 8 shows one example of a destination of a vehicle.

FIG. 9 shows one example of the destination of the vehicle.

FIG. 10 is a block diagram showing configurations of a driver abnormality response device and a driver abnormality response system in Modification 1 of Embodiment 2.

FIG. 11 shows one example of a display screen displayed by a notification device.

FIG. 12 shows one example of the display screen displayed by the notification device.

FIG. 13 shows one example of the display screen displayed by the notification device.

FIG. 14 shows one example of the display screen displayed by the notification device.

FIG. 15 is a block diagram showing configurations of a driver abnormality response device and a driver abnormality response system in Embodiment 3.

FIG. 16 is a block diagram showing configurations of a driver abnormality response device and a driver abnormality response system in Modification 2 of Embodiment 3.

FIG. 17 is a block diagram showing configurations of a driver abnormality response device and a driver abnormality response system in Embodiment 4.

FIG. 18 is a flowchart showing operation of the driver abnormality response device in a driver abnormality response method in Embodiment 4.

FIG. 19 is a flowchart showing operation of the service facility in the driver abnormality response method in Embodiment 4.

FIG. 20 is a block diagram showing configurations of a driver abnormality response device in Embodiment 5 and devices operating in conjunction with the driver abnormality response device.

### DESCRIPTION OF EMBODIMENTS

### Embodiment 1

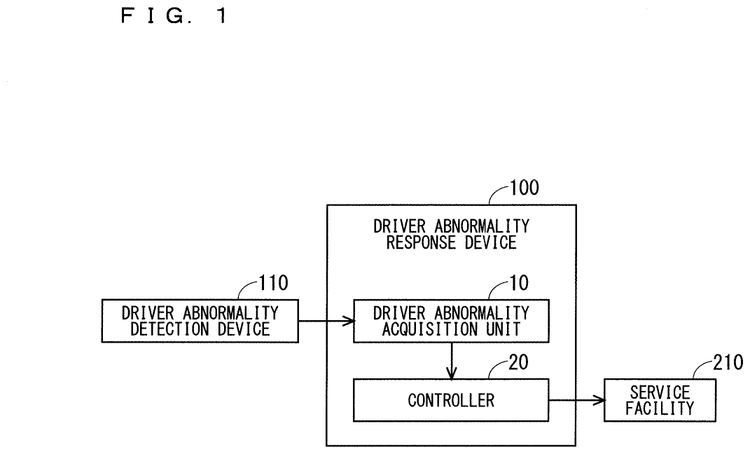

FIG. 1 is a block diagram showing a configuration of a driver abnormality response device 100 in Embodiment 1. The driver abnormality response device 100 includes a driver abnormality acquisition unit 10 and a controller 20. FIG. 1 shows a driver abnormality detection device 110 and a service facility 210 as devices operating in conjunction with the driver abnormality response device 100.

The driver abnormality detection device 110 detects an abnormal condition of a driver of a vehicle. The driver abnormality detection device 110 is provided in the vehicle.

The service facility 210 can perform remote operation on control of driving of the vehicle based on the abnormal condition of the driver by communicating with the vehicle.

The driver abnormality acquisition unit 10 acquires the abnormal condition of the driver of the vehicle from the driver abnormality detection device 110.

The controller 20 performs an intention check sequence for the driver based on the abnormal condition of the driver acquired by the driver abnormality acquisition unit 10. The intention check sequence is a sequence to check whether the driver has an intention to allow the service facility 210 to perform the remote operation. Based on a result of the intention check sequence, the controller 20 authorizes the service facility 210 to perform the remote operation on the control of driving of the vehicle.

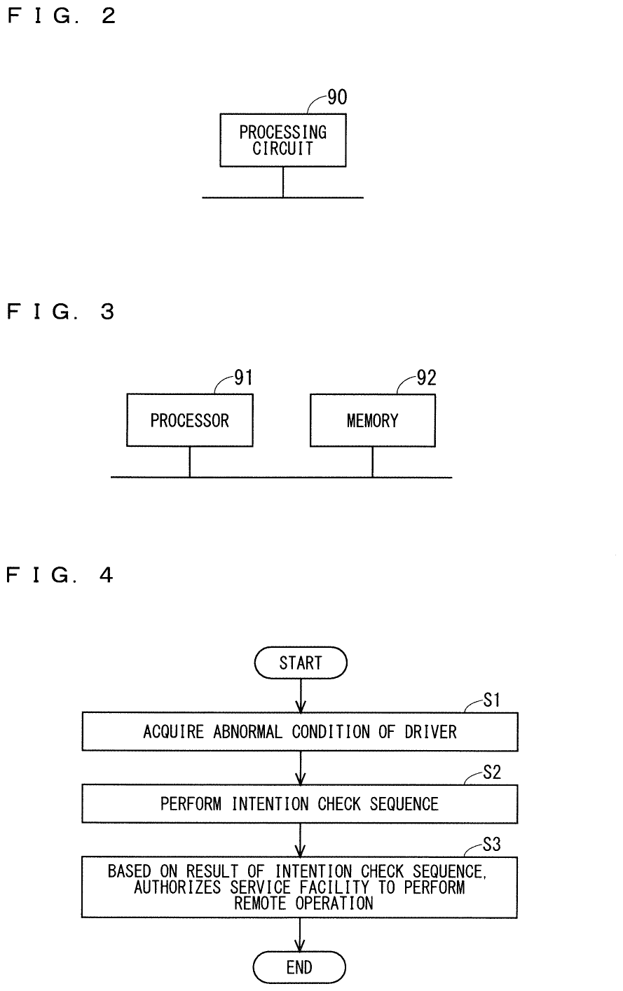

FIG. 2 shows one example of a configuration of a processing circuit 90 of the driver abnormality response device 100. Functions of the driver abnormality acquisition unit 10 and the controller 20 are achieved by the processing circuit 90. That is to say, the processing circuit 90 includes the driver abnormality acquisition unit 10 and the controller 20.

When the processing circuit 90 is dedicated hardware, the processing circuit 90 is, for example, a single circuit, a composite circuit, a programmed processor, a parallel-programmed processor, an application specific integrated circuit (ASIC), a field-programmable gate array (FPGA), or a circuit as a combination of them. The functions of the driver abnormality acquisition unit 10 and the controller 20 may be achieved separately by a plurality of processing circuits or may be achieved collectively by a single processing circuit.

FIG. 3 shows another example of the configuration of the processing circuit of the driver abnormality response device 100. The processing circuit includes a processor 91 and memory 92. The functions of the driver abnormality acquisition unit 10 and the controller 20 are achieved by the processor 91 executing a program stored in the memory 92. For example, the functions are achieved by the processor 91 executing software or firmware described as the program. That is to say, the driver abnormality response device 100 includes the memory 92 to store the program and the processor 91 to execute the program.

Described in the program is a function of the driver abnormality response device 100 to acquire the abnormal condition of the driver of the vehicle, perform, based on the abnormal condition of the driver, the intention check sequence to check whether the driver has the intention to allow the service facility 210 capable of performing the remote operation on the control of driving of the vehicle to perform the remote operation, and authorize, based on the result of the intention check sequence, the service facility 210 to perform the remote operation. The program is also to cause a computer to perform procedures or methods of the driver abnormality acquisition unit 10 and the controller 20.

The processor 91 is, for example, a central processing unit (CPU), an arithmetic unit, a microprocessor, a microcomputer, and a digital signal processor (DSP). The memory 92 is, for example, nonvolatile or volatile semiconductor memory, such as random access memory (RAM), read only memory (ROM), flash memory, erasable programmable read only memory (EPROM), and electrically erasable programmable read only memory (EEPROM). The memory 92 may be any storage medium to be used in the future, such as a magnetic disk, a flexible disk, an optical disc, a compact disc, a mini disc, and a DVD.

Some of the above-mentioned functions of the driver abnormality acquisition unit 10 and the controller 20 may be achieved by the dedicated hardware, and the other functions may be achieved by software or firmware. As described above, the processing circuit achieves the above-mentioned functions by the hardware, the software, the firmware, or a combination of them.

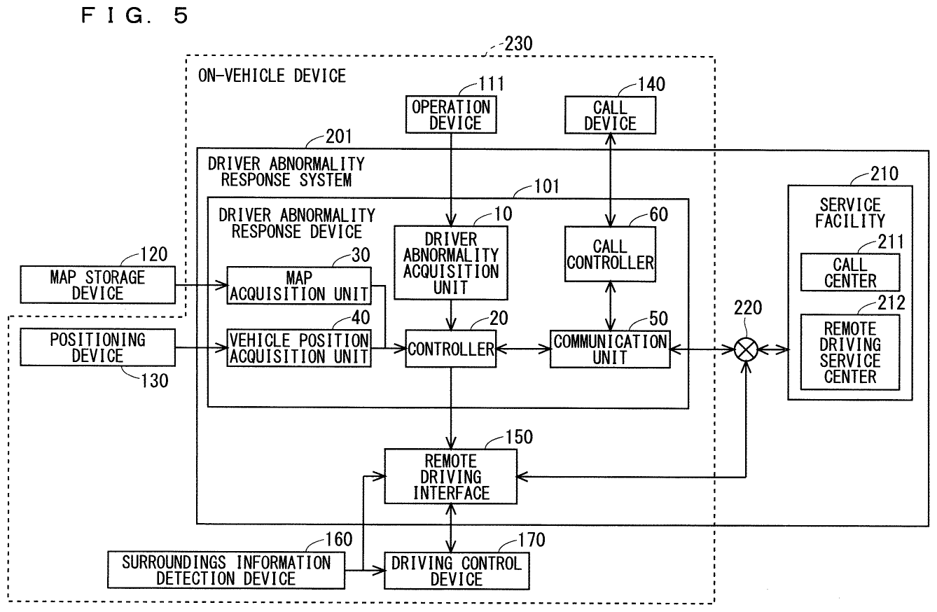

FIG. 4 is a flowchart showing operation of the driver abnormality response device 100 and a driver abnormality response method in Embodiment 1.

In step S1, the driver abnormality acquisition unit 10 acquires the abnormal condition of the driver from the driver abnormality detection device 110.

In step S2, the controller 20 performs the intention check sequence.

In step S3, based on the result of the intention check sequence, the controller 20 authorizes the service facility 210 to perform the remote operation.

In summary, the driver abnormality response device 100 in Embodiment 1 includes the driver abnormality acquisition unit 10 and the controller 20. The driver abnormality acquisition unit 10 acquires the abnormal condition of the driver of the vehicle. Based on the abnormal condition of the driver, the controller 20 performs the intention check sequence to check whether the driver has the intention to allow the service facility 210 capable of performing the remote operation on the control of driving of the vehicle to perform the remote operation. Based on the result of the intention check sequence, the controller 20 authorizes the service facility 210 to perform the remote operation.

The driver abnormality response device 100 as described above determines, when the abnormality of the driver occurs, whether the driver has the intention to allow the service facility 210 to perform the remote operation on the control of driving of the vehicle. When the driver does not allow the service facility 210 to perform the remote operation, for example, the driver can select waiting on site to wait for a rescue team. On the other hand, when the driver allows the service facility 210 to perform the remote operation, the vehicle automatically travels to a medical facility and the like without driving operation by the driver through remote automatic driving operation performed by the service facility 210 or autonomous automatic driving control of the vehicle. Time from the occurrence of the abnormality of the driver to the start of first aid is thus reduced when the vehicle is in a drivable condition.

The driver abnormality response method in Embodiment 1 includes acquiring the abnormal condition of the driver of the vehicle, performing, based on the abnormal condition of the driver, the intention check sequence to check whether the driver has the intention to allow the service facility 210 capable of performing the remote operation on the control of driving of the vehicle to perform the remote operation, and authorizing, based on the result of the intention check sequence, the service facility 210 to perform the remote operation.

According to the driver abnormality response method as described above, whether the driver has the intention to allow the service facility 210 to perform the remote operation on the control of driving of the vehicle is determined when the abnormality of the driver occurs. When the driver does not allow the service facility 210 to perform the remote operation, for example, the driver can select waiting on site to wait for the rescue team. On the other hand, when the driver allows the service facility 210 to perform the remote operation, the vehicle automatically travels to the medical facility and the like without driving operation by the driver through remote driving operation performed by the service facility 210 or autonomous automatic driving control of the vehicle. The time from the occurrence of the abnormality of the driver to the start of the first aid is thus reduced when the vehicle is in the drivable condition.

### Embodiment 2

A driver abnormality response device, a driver abnormality response system, and a driver abnormality response method in Embodiment 2 will be described. Embodiment 2 is a subordinate concept of Embodiment 1, and the driver abnormality response device in Embodiment 2 includes the components of the driver abnormality response device in Embodiment 1. Description on similar components and operation to those in Embodiment 1 will be omitted.

FIG. 5 is a block diagram showing configurations of a driver abnormality response device 101 and a driver abnormality response system 201 in Embodiment 2.

FIG. 5 shows an operation device 111, a map storage device 120, a positioning device 130, a call device 140, a remote driving interface 150, a surroundings information detection device 160, and a driving control device 170 as devices operating in conjunction with the driver abnormality response device 101 or the driver abnormality response system 201.

The driver abnormality response system 201 includes the driver abnormality response device 101, the service facility 210, and the remote driving interface 150. The driver abnormality response device 101 includes the driver abnormality acquisition unit 10, the controller 20, a map acquisition unit 30, a vehicle position acquisition unit 40, a communication unit 50, and a call controller 60. The service facility 210 includes a call center 211 and a remote driving service center 212.

In Embodiment 2, the vehicle driven by the driver has a function to remotely receive operation of the driving control device 170. That is to say, the vehicle receives remote automatic driving operation as the remote operation on the control of driving. The remote automatic driving operation is operation to remotely drive the vehicle so that the vehicle travels automatically without being operated by the driver riding in the vehicle.

The call center 211 receives the abnormal condition of the driver by communicating with the vehicle via a communication network 220. Based on the abnormal condition of the driver, the call center 211 calls the driver to request rescue by a medical facility or an emergency moving body. For example, the call center 211 includes an output unit to notify the operator of the call center 211 of the abnormal condition of the driver and an input unit to input a request for rescue arranged by the operator. The abnormal condition of the driver includes a poor health condition of the mind or the body of the driver. The abnormal condition of the driver includes a chronic disease and a disease due to an accident or a natural disaster, for example. The medical facility includes an emergency hospital, for example. The emergency moving body in Embodiment 2 is an emergency vehicle, and includes an ambulance, a fire engine, or a police vehicle, for example.

The remote driving service center 212 has a remote automatic driving operation function. That is to say, the remote driving service center 212 performs remote automatic driving operation as the remote operation on the control of driving of the vehicle by communicating with the vehicle via the communication network 220. For example, the remote driving service center 212 includes an output unit to notify an operator of surroundings information of the vehicle and an input unit to receive input of the remote automatic driving operation from the operator. The operator of the remote driving service center 212 performs simulative driving operation on the vehicle as the remote automatic driving operation. The vehicle travels automatically in accordance with the simulative driving operation performed by the operator without being operated by the driver.

The map storage device 120 stores a map for travel of the vehicle. The map storage device 120 may be provided in a server (not shown) or may be mounted on the vehicle.

The positioning device 130 determines a current position of the vehicle based on a global navigation satellite system (GNSS) or a vehicle position sensor (not shown).

The operation device 111 is one example of the driver abnormality detection device 110 shown in Embodiment 1. The operation device 111 is an emergency button or a switch to be depressed by the driver when the abnormality of the driver occurs. The operation device 111 detects an intention to make an emergency request of the driver through operation of the driver.

The call device 140 includes a microphone and a speaker, for example. The call device 140 calls the driver by making an inquiry to the driver, and detecting a response to the inquiry from the driver.

The surroundings information detection device 160 detects the surroundings information of the vehicle required for the remote driving service center 212 to perform the remote automatic driving operation on the vehicle. The surroundings information detection device 160 is a camera, for example. The camera takes a video of surroundings of the vehicle corresponding to a video in the driver's field of view as the surroundings information of the vehicle required for the remote automatic driving operation.

The remote driving interface 150 receives the remote automatic driving operation from the remote driving service center 212, and outputs travel control information by the remote automatic driving operation to the driving control device 170. In other words, a function of the vehicle to remotely operate the driving control device 170 of the vehicle is achieved by the remote driving interface 150. The remote driving interface 150 also transmits, to the remote driving service center 212, information on the vehicle required for the remote driving service center 212 to perform the remote automatic driving operation. For example, the remote driving interface 150 transmits information on the driving control device 170 to the remote driving service center 212. Alternatively, the remote driving interface 150 transmits, to the remote driving service center 212, information on the current position of the vehicle detected by the positioning device 130 and the surroundings information of the vehicle detected by the surroundings information detection device 160, for example.

Based on the travel control information by the remote automatic driving operation received via the remote driving interface 150, the driving control device 170 controls travel of the vehicle. The driving control device 170 includes a travel actuator. The travel actuator includes a steering wheel, an accelerator, or a brake, for example.

The map acquisition unit 30 acquires the map from the map storage device 120.

The vehicle position acquisition unit 40 acquires the current position of the vehicle detected by the positioning device 130.

The driver abnormality acquisition unit 10 acquires the abnormal condition of the driver from the operation device 111.

The call controller 60 controls the call of the call device 140 to the driver. The call controller 60 controls output of the inquiry made by the call device 140 to the driver and input of the response from the driver, for example.

The communication unit 50 is connected to the communication network 220, and controls communication with the service facility 210.

The controller 20 performs the intention check sequence based on the abnormal condition of the driver acquired by the driver abnormality acquisition unit 10. The controller 20 in Embodiment 2 checks whether the driver has an intention to allow the remote driving service center 212 to perform the remote automatic driving operation in the intention check sequence. In this case, the controller 20 provides the driver with a notification to check the intention, and detects a response to the notification from the driver via the call controller 60.

The controller 20 may start the intention check sequence by itself upon acquisition of the abnormal condition of the driver, or may transmit the abnormal condition of the driver to the call center 211 via the communication unit 50 and the communication network 220 and start the intention check sequence based on a reply from the call center 211.

The controller 20 may determine the result of the intention check sequence based on a predetermined rule when the driver is determined to be unconscious by the intention check sequence. The predetermined rule stipulates that the driver is deemed to have the intention to allow the remote driving service center 212 to perform the remote automatic driving operation when the driver is unconscious, for example. Alternatively, the predetermined rule stipulates that the driver is deemed not to have the intention to allow the remote driving service center 212 to perform the remote automatic driving operation when the driver is unconscious.

Alternatively, the controller 20 may determine the result of the intention check sequence based on a record of the intention prespecified by the driver when the driver is determined to be unconscious by the intention check sequence. For example, the driver abnormality response device 101 includes a storage (not shown) to store information prespecifying whether the driver has the intention to allow the remote driving service center 212 to perform the remote automatic driving operation. The controller 20 may determine the result of the intention check sequence based on the information stored in the storage when the driver is determined to be unconscious. The information prespecified by the driver may be recorded as a contract with the service facility 210, for example. The information may not necessarily be stored in the storage of the driver abnormality response device 101, and may be stored in the service facility 210, for example.

Based on the result of the intention check sequence, the controller 20 authorizes the remote driving service center 212 to perform the remote automatic driving operation via the communication network 220. For example, the controller 20 authorizes the remote driving service center 212 via the communication network 220 and the call center 211. The controller 20 also controls the remote driving interface 150 so that the remote driving interface 150 receives the remote automatic driving operation from the remote driving service center 212.

The remote driving service center 212 is authorized by the driver abnormality response device 101 to perform the remote automatic driving operation on the vehicle as the remote operation on the control of driving of the vehicle. The remote driving service center 212 acquires the information required for the remote automatic driving operation from the driver abnormality response device 101 or the remote driving interface 150. For example, the remote driving service center 212 acquires the current position of the vehicle, information on the travel actuator of the driving control device 170, and the surroundings information of the vehicle.

Based on the current position of the vehicle and the surroundings information of the vehicle, the remote driving service center 212 remotely operates the travel actuator of the driving control device 170 to drive the vehicle. The remote driving service center 212 performs operation to cause the vehicle to arrive at the medical facility or the emergency vehicle for rescue of the driver, for example, as the remote automatic driving operation. Alternatively, the remote driving service center 212 performs operation to move the vehicle to stop the vehicle in an area suitable for rescue of the driver, for example, as the remote automatic driving operation. The area suitable for rescue of the driver is a roadside area or a parking space, for example. Alternatively, the remote driving service center 212 may activate an abnormal condition notification device (not shown) mounted on the vehicle, for example. The abnormal condition notification device is a device to notify the abnormality of the driver to the outside of the vehicle. The abnormal condition notification device includes hazard flashers, a special indicator light, and an inter-vehicle communication device, for example.

The above-mentioned function of the controller 20 is achieved by the processing circuit shown in FIG. 2 or 3. The remote driving service center 212 includes a processing circuit similar to the processing circuit shown in FIG. 2 or 3. The remote driving service center 212 sets a destination of the vehicle, and sets a travel path of the vehicle to the destination and a travel path of the emergency vehicle using the processing circuit. The destination is the medical facility, a position where the vehicle and the emergency vehicle meet each other, or a position suitable for rescue of the driver, for example.

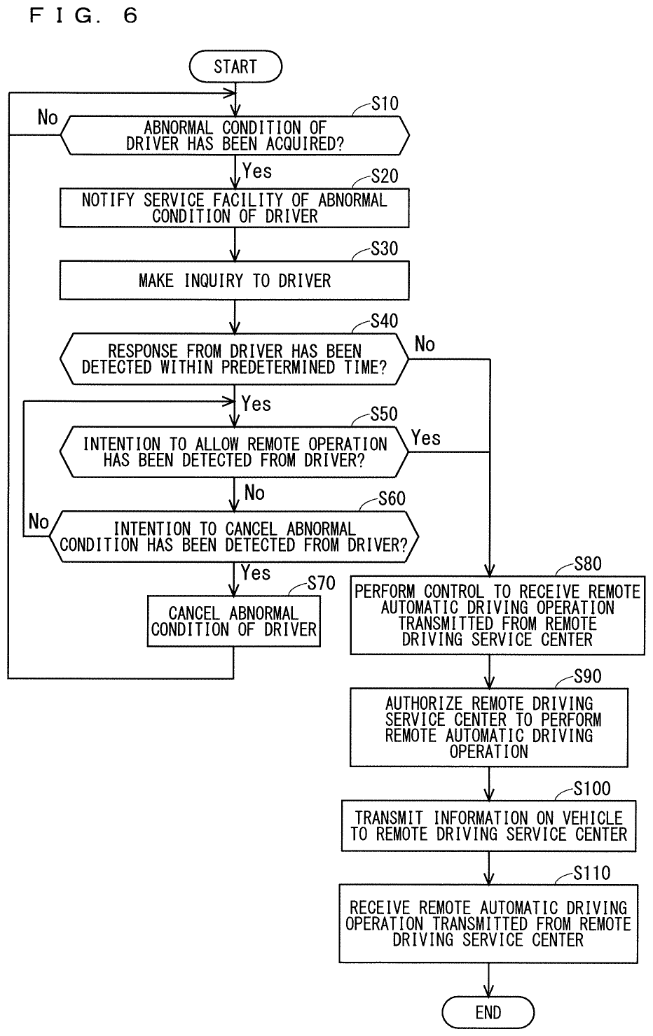

FIG. 6 is a flowchart showing operation of the driver abnormality response device 101 in the driver abnormality response method in Embodiment 2.

In step S10, the driver abnormality acquisition unit 10 determines whether the abnormal condition of the driver has been acquired. The driver abnormality acquisition unit 10 acquires the abnormal condition of the driver, for example, when the driver depresses the emergency button as the operation device 111. When the driver abnormality acquisition unit 10 has acquired the abnormal condition of the driver, step S20 is performed. When the driver abnormality acquisition unit 10 has not acquired the abnormal condition of the driver, step S10 is repeatedly performed.

In step S20, the controller 20 notifies the service facility 210 of the abnormal condition of the driver. The controller 20 herein notifies the call center 211 of the abnormal condition of the driver via the communication unit 50 and the communication network 220.

In step S30, the call controller 60 makes an inquiry to the driver. When the communication unit 50 has received an inquiry to the driver, such as “How can I help you?”, from the call center 211, for example, the call controller 60 makes the inquiry. Alternatively, the controller 20 may make the inquiry by itself via the call controller 60, for example.

In step S40, the controller 20 determines whether a response from the driver has been detected within a predetermined time. The response includes a voice response from the driver or a response made through operation on an input device (not shown) provided in the vehicle. When the response has been detected within the predetermined time, the controller 20 determines that the driver is conscious, and step S50 is performed. When the response has not been detected within the predetermined time, the controller 20 determines that the driver is unconscious. The controller 20 herein determines the result of the intention check sequence in accordance with the predetermined rule when the driver is unconscious. The predetermined rule stipulates that the driver is deemed to have the intention to allow the remote driving service center 212 to perform the remote automatic driving operation when the driver is unconscious. Step S80 is then performed.

In step S50, the controller 20 determines whether the intention to allow the remote operation has been detected from the driver. For example, the controller 20 determines whether the intention to allow the remote driving service center 212 to perform the remote automatic driving operation on the vehicle is included in the response from the driver detected in step S40. When the controller 20 detects the intention to allow the remote automatic driving operation, step S80 is performed. When the controller 20 does not detect the intention to allow the remote automatic driving operation, step S60 is performed.

In step S60, the controller 20 determines whether an intention to cancel the abnormal condition has been detected from the driver. When the controller 20 detects the intention to cancel the abnormal condition, step S70 is performed. When the abnormal condition is erroneous, and the first aid is not necessary, for example, the driver inputs the intention to cancel the abnormal condition into the input device. On the other hand, when the controller 20 does not detect the intention to cancel the abnormal condition, step S50 is performed again.

In step S70, the controller 20 cancels the abnormal condition of the driver. Step S10 is performed again.

In step S80, the controller 20 controls the remote driving interface 150 so that the remote driving interface 150 receives the remote automatic driving operation transmitted from the remote driving service center 212.

In step S90, the controller 20 authorizes the remote driving service center 212 to perform the remote automatic driving operation. The controller 20 herein delegates authority to the call center 211 to authorize the remote driving service center 212. The remote driving service center 212 to be authorized is determined by the call center 211, for example. The controller 20 also notifies the call center 211 of determination to perform the first aid.

In step S100, the controller 20 or the remote driving interface 150 transmits, to the remote driving service center 212, the information on the vehicle required for the remote automatic driving operation. The controller 20 herein transmits information on the current position of the vehicle to the remote driving service center 212. Furthermore, the remote driving interface 150 transmits video of the surroundings of the vehicle to the remote driving service center 212.

In step S110, the remote driving interface 150 receives the remote automatic driving operation transmitted from the remote driving service center 212. For example, the remote interface 150 receives a remote driving signal corresponding to the remote automatic driving operation via the communication network 220, and outputs the travel control information based on the remote driving signal to the driving control device 170. Based on the travel control information, the driving control device 170 controls travel of the vehicle.

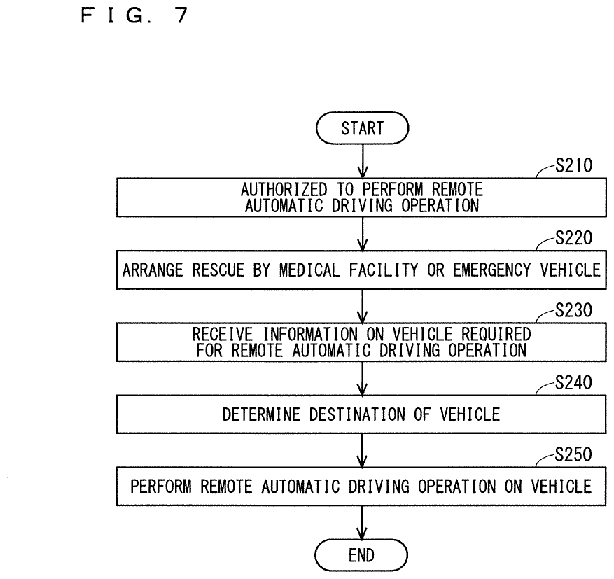

FIG. 7 is a flowchart showing operation of the service facility 210 in the driver abnormality response method in Embodiment 2.

In step S210, the remote driving service center 212 is authorized by the driver abnormality response device 101 to perform the remote automatic driving operation.

In step S220, based on the determination to perform the first aid notified by the driver abnormality response device 101, the call center 211 arranges rescue of the driver by the medical facility or the emergency vehicle. The call center 211 herein arranges both the medical facility and the emergency vehicle, for example.

In step S230, the remote driving service center 212 receives the information on the vehicle required for the remote automatic driving operation transmitted from the driver abnormality response device 101. The remote driving service center 212 herein receives the current position of the vehicle, the information on the travel actuator of the driving control device 170, and information on the video of the surroundings of the vehicle. The remote driving service center 212 also acquires an emergency point of view on the abnormal condition of the driver determined by the call center 211.

In step S240, based on the position of the medical facility or the emergency vehicle, the current position of the vehicle in which the abnormality of the driver occurs, and the emergency point of view, the remote driving service center 212 determines the destination of the vehicle.

In step S250, the remote driving service center 212 performs the remote automatic driving operation on the vehicle to cause the vehicle to arrive at the destination. In this case, information on the remote automatic driving operation is transmitted to the remote driving interface 150 via the communication network 220, and step S110 described above is performed.

The driver abnormality response method thus ends.

In step S240 described above, the remote driving service center 212 calculates the destination of the vehicle using the above-mentioned processing circuit. One example of logic of calculation is shown in (1) to (3) below.

(1) The remote driving service center 212 sets the position where the emergency vehicle and the vehicle meet each other to the destination of the vehicle, and performs the remote operation.

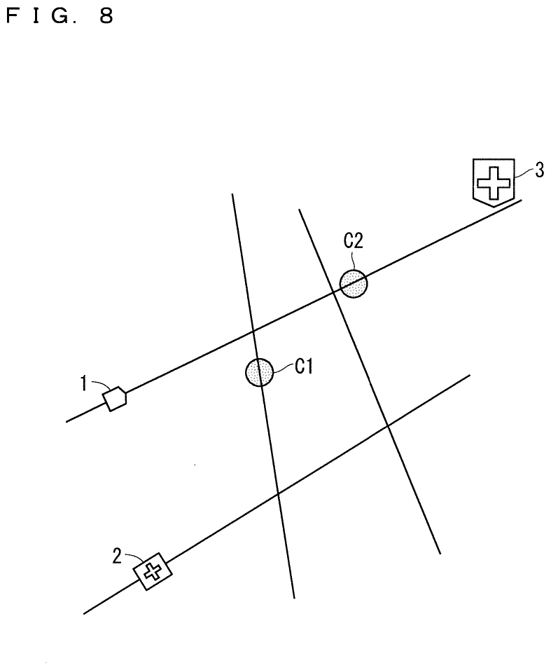

FIG. 8 shows one example of the destination of a vehicle 1. The remote driving service center 212 sets a position C1 where an emergency vehicle 2 and the vehicle 1 can meet each other in the shortest time to the destination of the vehicle 1, for example. Alternatively, the remote driving service center 212 sets a position C2 where the emergency vehicle 2 can arrive at a medical facility 3 in the shortest time after the emergency vehicle 2 and the vehicle 1 meet each other to the destination of the vehicle 1, for example. The emergency vehicle 2 picks the driver up at the position C1 or at the position C2, and takes the driver to the medical facility 3.

When the driver is required to receive the first aid as soon as possible, the remote driving service center 212 prioritizes the position C1 over the position C2, and sets the position C1 to the destination of the vehicle 1 in view of the information as the emergency point of view.

The remote driving service center 212 may receive a road traffic condition, such as traffic congestion, and calculate the meeting position in view of the road traffic condition. The emergency vehicle 2 can arrive at the meeting position early by suppressing travel of general vehicles with an emergency display or a siren even if a road is congested.

(2) The remote driving service center 212 sets the medical facility 3 to the destination of the vehicle 1, and performs the remote operation.

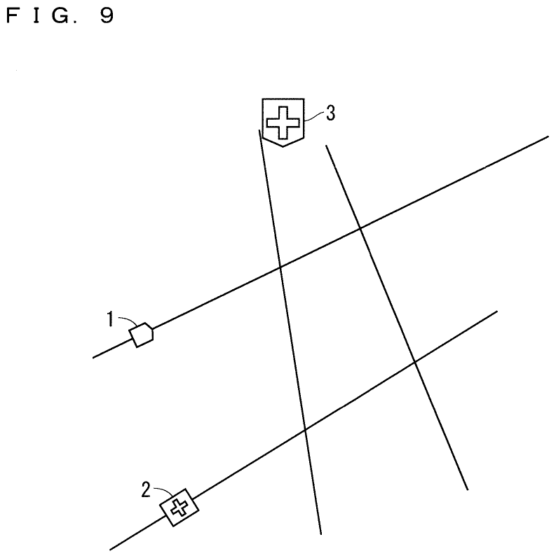

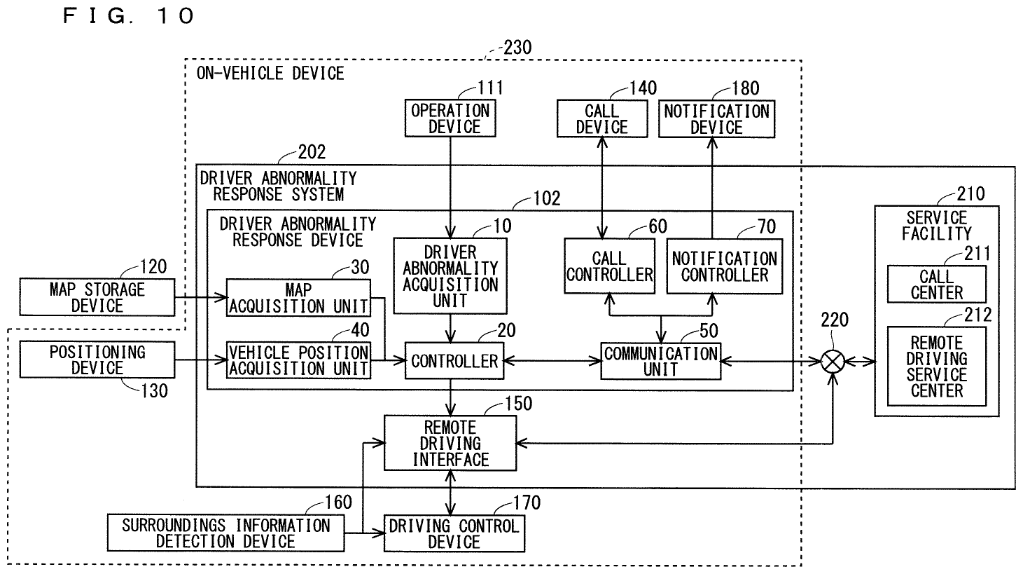

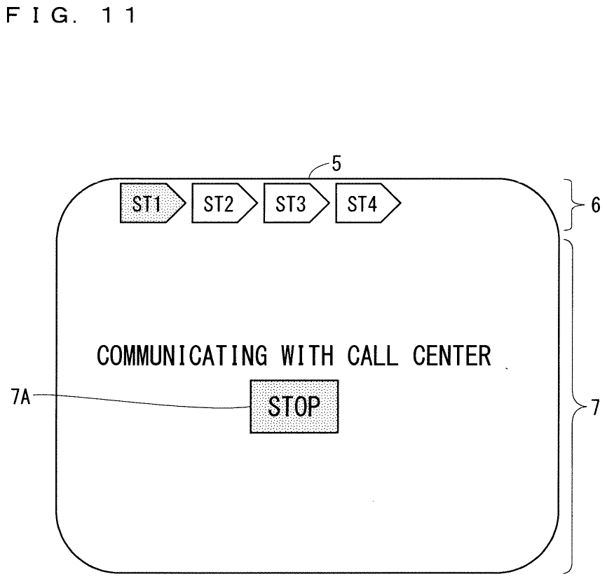

FIG. 9 shows one example of the destination of the vehicle 1. The remote driving service center 212 sets the medical facility 3 to the destination of the vehicle 1 when the vehicle 1 can take the driver to the medical facility 3 earlier by directly heading for the medical facility 3 than by meeting the emergency vehicle 2.

(3) The remote driving service center 212 sets an area in which it is easy for the emergency vehicle 2 to perform rescue operation on the driver, that is, the area suitable for rescue of the driver to the destination of the vehicle 1, and performs the remote operation.

The area suitable for rescue of the driver is a parking area, a roadside area wider than the other roadside area, or an area with less traffic, for example.

The remote driving service center 212 calculates the destination of the vehicle using the above-mentioned logic of calculation.

In Embodiment 2, the driver abnormality response device 101, the operation device 111, the positioning device 130, the call device 140, the remote driving interface 150, the surroundings information detection device 160, and the driving control device 170 are an on-vehicle device 230 mounted on the vehicle 1. The driver abnormality response device 101, however, may not necessarily be mounted on the vehicle 1, and may be provided in the server and the like. The controller 20 of the driver abnormality response device 101 may include the remote driving interface 150.

The call center 211 may have a remote automatic driving function. In this case, the call center 211 performs the remote automatic driving operation on the vehicle 1 on behalf of the remote driving service center 212. In this case, the call center 211 includes the processing circuit similar to the processing circuit shown in FIG. 2 or 3 to achieve the above-mentioned function of the remote driving service center 212.

In summary, in the driver abnormality response device 101 in Embodiment 2, the remote operation on the control of driving of the vehicle 1 is the remote automatic driving operation to remotely drive the vehicle 1 so that the vehicle 1 travels automatically.

The driver abnormality response device 101 as described above can accurately determine whether to cause the service facility 210 to perform the remote automatic driving operation on the vehicle 1 based on the intention of the driver. The driver abnormality response system 201 allows for movement of the vehicle 1 to the medical facility 3 or the emergency vehicle 2 through the remote automatic driving operation performed by the service facility 210. As a result, the time from the occurrence of the abnormality of the driver to the start of the first aid is reduced.

In a system in which the rescue team rushes to the vehicle stopping due to the poor health condition of the driver for rescue, the driver is required to wait for arrival of the rescue team. The driver thus has missed the opportunity to receive the first aid early. The driver abnormality response device 101 in Embodiment 2 solves such a problem.

The driver abnormality response device 101 in Embodiment 2 performs the intention check sequence in cooperation with the call center 211 even if a vital sign of the driver is deteriorated. The driver abnormality response system 201 thus allows for guidance of the vehicle 1 to the appropriate medical facility 3 in accordance with the abnormal condition of the driver. When the emergency vehicle 2 is closer to the vehicle 1 of the driver than the medical facility 3 is, the driver abnormality response system 201 performs control so that the emergency vehicle 2 and the vehicle 1 meet each other to allow the driver to receive the first aid early.

The remote automatic driving operation in Embodiment 2 includes the operation to cause the vehicle 1 to arrive at the medical facility 3 or the emergency moving body for rescue of the driver. The emergency moving body in Embodiment 2 is the emergency vehicle 2.

The driver abnormality response device 101 and the driver abnormality response system 201 as described above reduce the time from the occurrence of the abnormality of the driver to the start of the first aid.

The remote automatic driving operation in Embodiment 2 also includes the operation to move the vehicle 1 to stop the vehicle 1 in the area suitable for rescue of the driver.

The driver abnormality response device 101 and the driver abnormality response system 201 as described above facilitate the rescue operation of the emergency vehicle 2 on the driver.

The area suitable for rescue of the driver in Embodiment 2 includes the roadside area.

The driver abnormality response device 101 and the driver abnormality response system 201 as described above facilitate the rescue operation of the emergency vehicle 2 on the driver.

The area suitable for rescue of the driver in Embodiment 2 includes the parking space.

The driver abnormality response device 101 and the driver abnormality response system 201 as described above facilitate the rescue operation of the emergency vehicle 2 on the driver.

The controller 20 of the driver abnormality response device 101 in Embodiment 2 provides the driver with the notification to check whether the driver has the intention, and detects the response to the notification from the driver, thereby performing the intention check sequence. The result of the intention check sequence includes the response from the driver.

The driver abnormality response device 101 as described above can cause the service facility 210 to accurately perform the remote automatic driving operation based on the intention of the driver.

The controller 20 of the driver abnormality response device 101 in Embodiment 2 determines the result of the intention check sequence based on the predetermined rule when the driver is determined to be unconscious by the intention check sequence.

The driver abnormality response device 101 as described above can accurately determine whether to cause the service facility 210 to perform the remote automatic driving operation even if the driver is unconscious.

The predetermined rule in Embodiment 2 includes a rule that deems the driver to have the intention or not to have the intention when the driver is unconscious.

The driver abnormality response device 101 as described above can accurately determine whether to cause the service facility 210 to perform the remote automatic driving operation even if the driver is unconscious.

The controller 20 of the driver abnormality response device 101 in Embodiment 2 determines the result of the intention check sequence based on the record of the intention prespecified by the driver when the driver is determined to be unconscious by the intention check sequence.

The driver abnormality response device 101 as described above can accurately determine whether to cause the service facility 210 to perform the remote automatic driving operation even if the driver is unconscious.

The service facility 210 in Embodiment 2 includes the call center 211 to receive the abnormal condition of the driver acquired by the driver abnormality acquisition unit 10 and the remote driving service center 212 capable of performing the remote automatic driving operation. The controller 20 starts the intention check sequence based on a communication from the call center 211 having received the abnormal condition of the driver. Based on the result of the intention check sequence, the controller 20 authorizes the remote driving service center 212 via the call center 211.

The driver abnormality response device 101 as described above can accurately determine whether to cause the remote driving service center 212 to perform the remote automatic driving operation by cooperating with the call center 211.

(Modification 1 of Embodiment 2)

FIG. 10 is a block diagram showing configurations of a driver abnormality response device 102 and a driver abnormality response system 202 in Modification 1 of Embodiment 2.

The driver abnormality response device 102 further includes a notification controller 70. The notification controller 70 performs control to cause a notification device 180 provided in the vehicle 1 to sequentially provide notifications of information (a) to (d) below. The notification device 180 sequentially provides, in accordance with control performed by the notification controller 70, notifications (a) that the intention check sequence has been started, (b) that the service facility 210 has been authorized, (c) of the positional relationship among the medical facility 3 and the emergency vehicle 2 arranged by the authorized service facility 210 and the vehicle 1, and (d) of time required for the vehicle 1 to arrive at the medical facility 3 or to meet the emergency vehicle 2. The notification device 180 provides notifications of (a) to (d) by sounds or by display, for example. The function of the notification controller 70 is achieved by the processing circuit shown in FIG. 2 or 3.

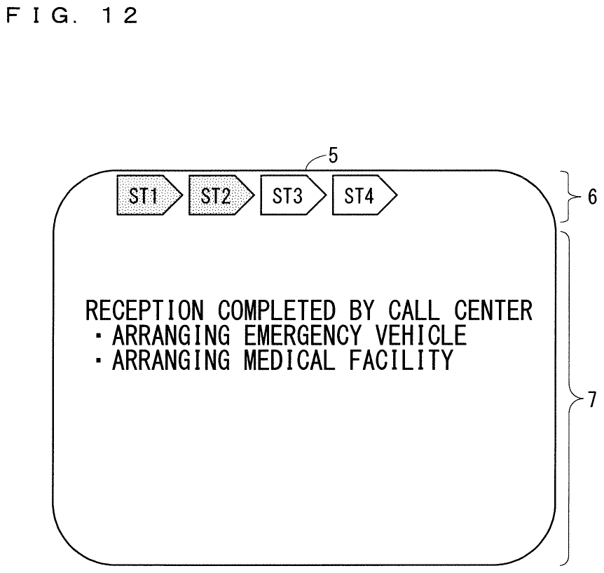

FIGS. 11 to 14 each show one example of a display screen 5 displayed by the notification device 180. The notification device 180 displays, on the display screen 5, a current progress 6 in all the steps of the driver abnormality response method and a processing state 7 in a current step.

As shown in FIG. 11, the notification device 180 displays a state of communicating with the call center 211 as the processing state 7 in the current step. A cancel button 7A is displayed on the display screen 5.

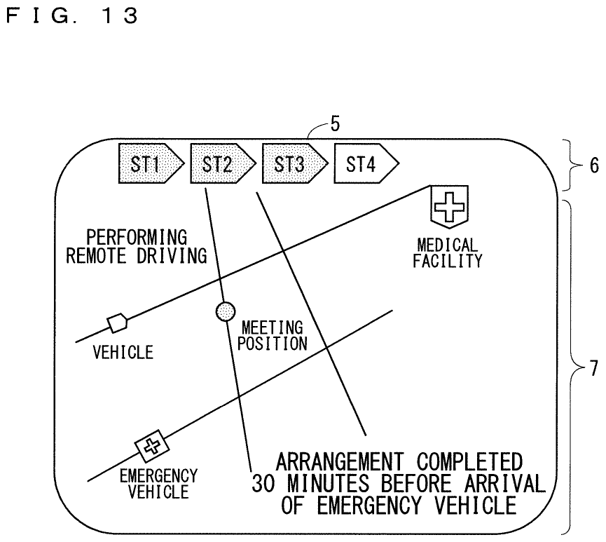

After the display screen 5 shown in FIG. 11, the display screen 5 shown in FIG. 12 is displayed. The notification device 180 displays a state of the call center 211 having received the determination to perform the first aid, arranging the emergency vehicle 2, and arranging the medical facility 3 as the processing state 7 in the current step.

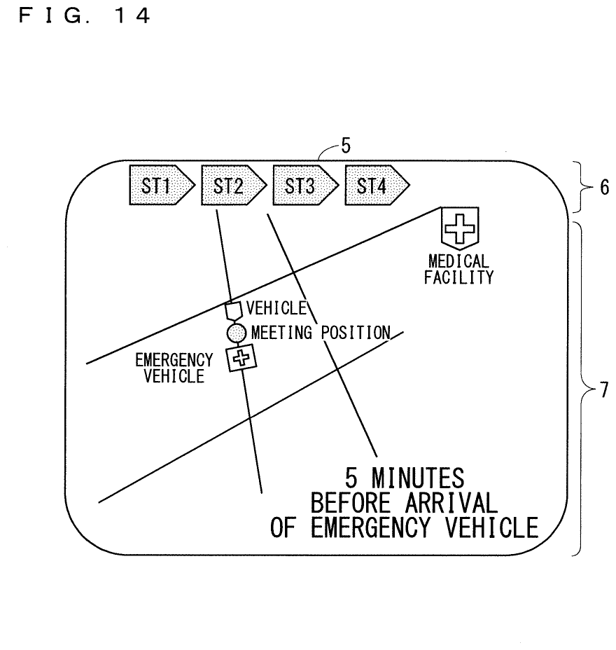

After the display screen 5 shown in FIG. 12, the display screen 5 shown in FIG. 13 is displayed. The notification device 180 displays, on the map, the position of the medical facility 3, the position of the emergency vehicle 2, the position of the vehicle 1, and the meeting position. The notification device 180 displays a state of performing the remote automatic driving operation on the vehicle 1, having completed arrangement of an emergency facility, and requiring 30 minutes for the vehicle 1 to arrive at the position where the vehicle 1 and the emergency vehicle 2 meet each other as the processing state 7 in the current step. As for processes to arrange the emergency vehicle 2, arrange the medical facility 3, start the remote automatic driving operation, and set the meeting position, the notification device 180 may sequentially display the processes on the map in an order in which the processes are completed.

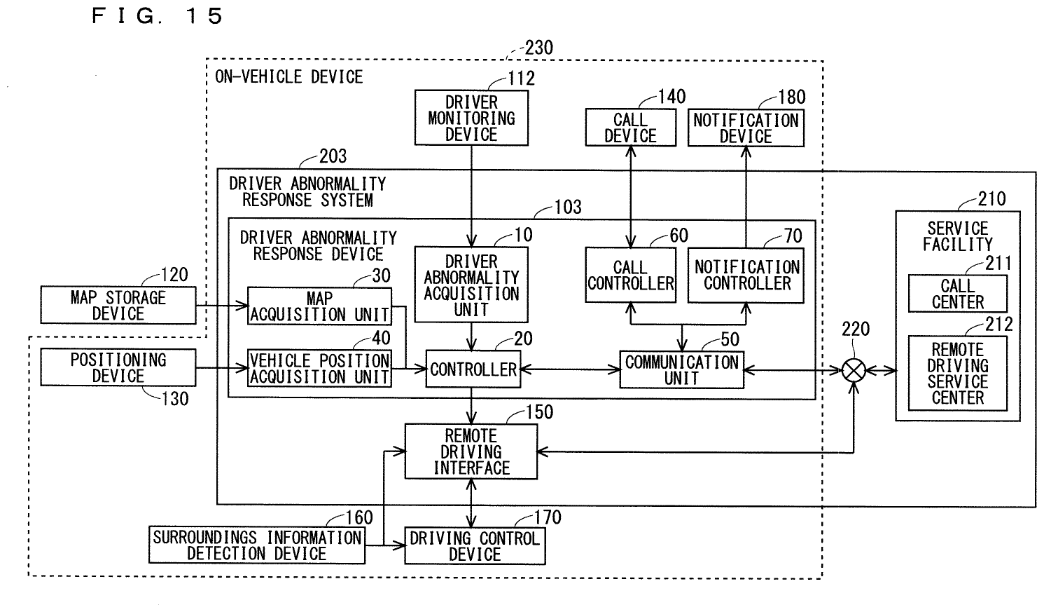

After the display screen 5 shown in FIG. 13, the display screen 5 shown in FIG. 14 is displayed. The notification device 180 displays a state of requiring five minutes for the vehicle 1 to arrive at the position where the vehicle 1 and the emergency vehicle 2 meet each other as the processing state 7 in the current step.

By performing such notification control, the driver abnormality response device 102 can encourage the driver to sustain vitality of the driver. The driver abnormality response device 102 may bidirectionally transmit and receive videos and sounds as in a videophone in cooperation with the notification device 180 and the call device 140. The driver abnormality response device 102 thus allows for a conversation between the driver and the call center 211.

(Modification 2 of Embodiment 2)

The controller 20 of the driver abnormality response device in Modification 2 of Embodiment 2 transmits identification information associated with the vehicle 1 to the remote driving interface 150 and the remote driving service center 212 when the driver has the intention to allow the remote driving service center 212 to perform the remote automatic driving operation. The controller 20 herein transmits, as the identification information, an authentication code to the remote driving interface 150 and the remote driving service center 212. The controller 20 may transmit the authentication code to the remote driving service center 212 via the call center 211.

The remote driving service center 212 transmits the authentication code to the remote driving interface 150 along with the information on the remote automatic driving operation.

The remote driving interface 150 compares the authentication code transmitted from the controller 20 to the remote driving interface 150 and the authentication code transmitted from the remote driving service center 212. When the authentication codes match as a result of comparison, the remote driving interface 150 receives the remote automatic driving operation performed by the remote driving service center 212. When the authentication codes do not match, the remote driving interface 150 does not receive the remote automatic driving operation. When the authentication codes do not match, the driver abnormality response device may operate to transmit a notification that an unauthorized authentication code has been received to the call center 211, and ask for rescue again. The remote driving interface 150 includes the processing circuit similar to the processing circuit shown in FIG. 2 or 3, and the above-mentioned function of the remote driving interface 150 is achieved by the processing circuit.

The driver abnormality response system as described above can prevent unauthorized remote automatic driving operation on the vehicle 1.

(Modification 3 of Embodiment 2)

The call center 211 or the remote driving service center 212 in Modification 3 of Embodiment 2 remotely performs environment control operation on the vehicle 1 to improve the condition of the driver to a proper condition when authorized by the controller 20 to perform the remote automatic driving operation on the vehicle 1. The environment control operation on the vehicle 1 includes operation to remotely adjust air conditioning of the vehicle 1, operation to remotely adjust opening and closing of a window of the vehicle 1, or operation to remotely adjust an angle of a seat of the vehicle 1 depending on the condition of the driver.

(Modification 4 of Embodiment 2)

The emergency vehicle 2 in Modification 4 of Embodiment 2 has the remote automatic driving operation function. The emergency vehicle 2 having the remote automatic driving function is included in the service facility 210. Based on the result of the intention check sequence, the controller 20 of the driver abnormality response device authorizes the emergency vehicle 2 to perform the remote automatic driving operation on the vehicle 1 via the call center 211. The emergency vehicle 2 performs the remote automatic driving operation on the vehicle 1 on behalf of the remote driving service center 212.

The driver abnormality response system as described above can move the vehicle 1 to a place convenient to rescue the driver when the emergency vehicle 2 approaches the vehicle 1, for example.

The medical facility 3 may similarly have the remote automatic driving function. The medical facility 3 having the remote automatic driving function is included in the service facility 210. Based on the result of the intention check sequence, the controller 20 authorizes the medical facility 3 to perform the remote automatic driving operation on the vehicle 1. The medical facility 3 performs the remote automatic driving operation on the vehicle 1 on behalf of the remote driving service center 212.

(Modification 5 of Embodiment 2)

The emergency moving body arranged by the call center 211 is not limited to the emergency vehicle 2. The emergency moving body may be a helicopter or a vessel, for example.

(Modification 6 of Embodiment 2)

The helicopter or the vessel as the emergency moving body arranged by the call center 211 may have the remote automatic driving function. The helicopter or the vessel having the remote automatic driving function is included in the service facility 210. Based on the result of the intention check sequence, the controller 20 authorizes the helicopter or the vessel to perform the remote automatic driving operation on the vehicle 1. The helicopter or the vessel performs the remote automatic driving operation on the vehicle 1 on behalf of the remote driving service center 212. The helicopter or the vessel includes the processing circuit similar to the processing circuit shown in FIG. 2 or 3 to achieve the above-mentioned function of the remote driving service center 212.

### Embodiment 3

A driver abnormality response device, a driver abnormality response system, and a driver abnormality response method in Embodiment 3 will be described. Embodiment 3 is a subordinate concept of Embodiment 1, and the driver abnormality response device in Embodiment 3 includes the components of the driver abnormality response device in Embodiment 1. Description on similar components and operation to those in Embodiment 1 or 2 will be omitted.

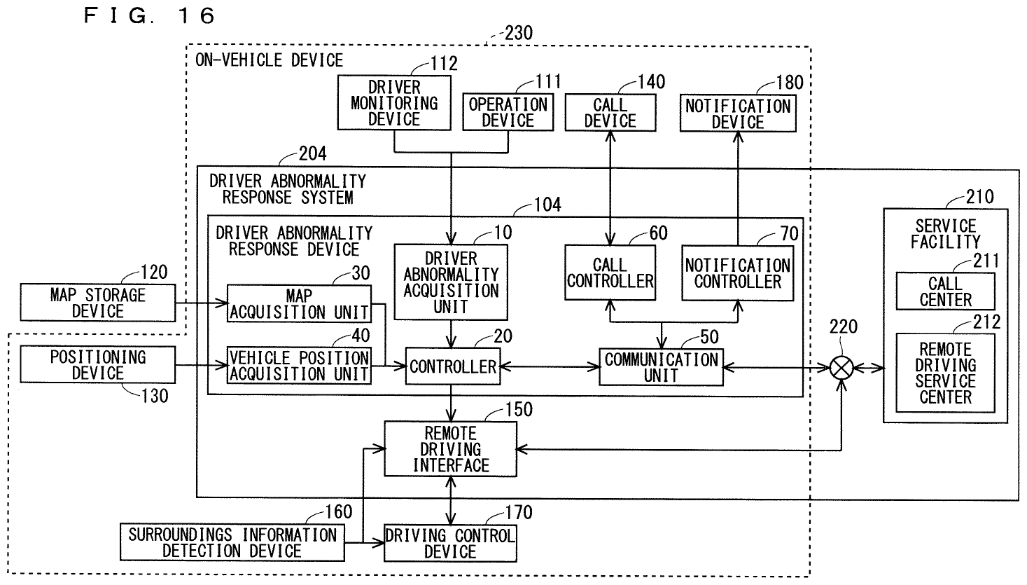

FIG. 15 is a block diagram showing configurations of a driver abnormality response device 103 and a driver abnormality response system 203 in Embodiment 3. The driver abnormality response system 203 in Embodiment 3 is different from the driver abnormality response system 203 in Embodiment 2 in that a driver monitoring device 112 is included as the driver abnormality detection device 110.

The driver monitoring device 112 is a device to take an image of the driver and detect an abnormal condition of the driver by image processing, for example. The driver monitoring device 112 may be a physiological measurement sensor to sense the pulse, respiration, brain waves, or the like of the driver, for example.

When the driver monitoring device 112 detects the abnormal condition of the driver, the driver abnormality acquisition unit 10 of the driver abnormality response device 103 determines that the abnormal condition of the driver has been acquired in step S10 shown in FIG. 6. The steps thereafter are similar to those shown in FIGS. 6 and 7.

(Modification 1 of Embodiment 3)

When the driver monitoring device 112 includes a camera, the controller 20 may transmit a video of the driver to the call center 211 along with a notification of the abnormal condition of the driver in step S20 shown in FIG. 6. The call center 211 arranges a medical facility 3 to which a specialist suitable for the first aid belongs or a specially equipped medical facility 3 based on the video of the driver in step S220 shown in FIG. 7. For example, medical staff of the call center 211 may visually check the condition of the driver, and arrange the medical facility 3.

When the driver monitoring device 112 includes the physiological measurement sensor, the controller 20 may transmit physiological information of the driver to the call center 211 along with the notification of the abnormal condition of the driver in step S20 shown in FIG. 6. The call center 211 arranges the medical facility 3 based on the physiological information of the driver. The driver abnormality response system can thereby arrange an accurate medical facility 3 after properly determining a psychosomatic condition of the driver.

A driver monitoring system may have a configuration allowing for having a conversation while viewing each other as in a videophone as shown in Modification 1 of Embodiment 2.

(Modification 2 of Embodiment 3)

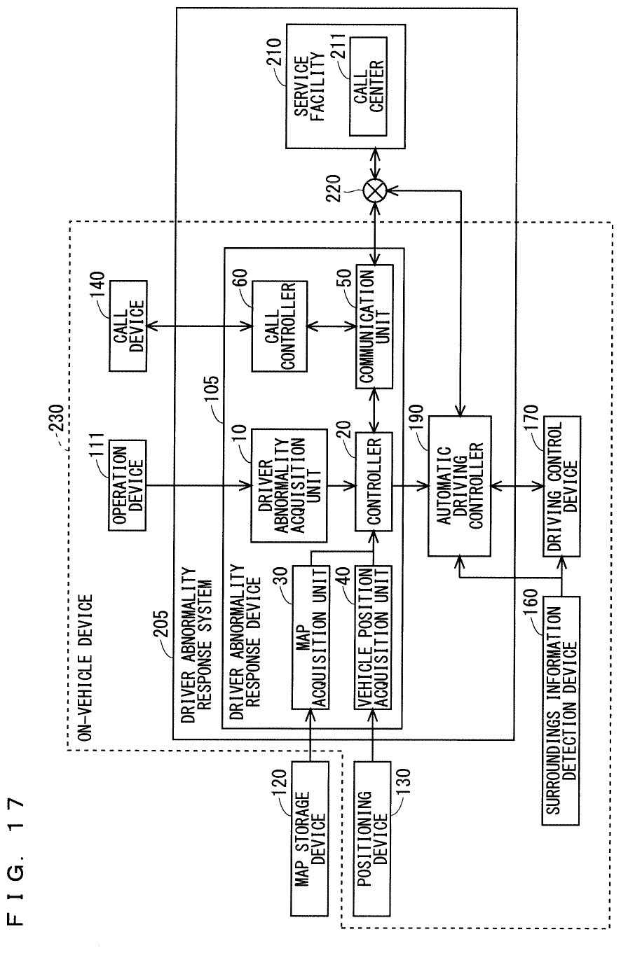

FIG. 16 is a block diagram showing configurations of a driver abnormality response device 104 and a driver abnormality response system 204 in Modification 2 of Embodiment 3.

The driver abnormality response system 204 in Modification 2 of Embodiment 3 includes, as the driver abnormality detection device 110, both the operation device 111 shown in Embodiment 2 and the driver monitoring device 112 shown in Embodiment 3.

When the driver monitoring device 112 detects the abnormal condition of the driver or when the driver depresses the operation device 111, the driver abnormality acquisition unit 10 of the driver abnormality response device 104 determines that the abnormal condition of the driver has been acquired in step S10 shown in FIG. 6. The steps thereafter are similar to those shown in FIGS. 6 and 7.

### Embodiment 4

A driver abnormality response device, a driver abnormality response system, and a driver abnormality response method in Embodiment 4 will be described. Embodiment 4 is a subordinate concept of Embodiment 1, and the driver abnormality response device in Embodiment 4 includes the components of the driver abnormality response device in Embodiment 1. Description on similar components and operation to those in any of Embodiments 1 to 3 will be omitted.

The vehicle driven by the driver in Embodiment 4 has an automatic driving control function at or above Level 4. The vehicle in Embodiment 4 does not travel to the destination through the remote automatic driving operation performed by the remote driving service center 212 as with the vehicle 1 in Embodiment 2, but has a function to travel to the destination autonomously. The vehicle in Embodiment 4 and the vehicle 1 in Embodiment 2 are different from each other in whether to have an autonomous automatic driving function.

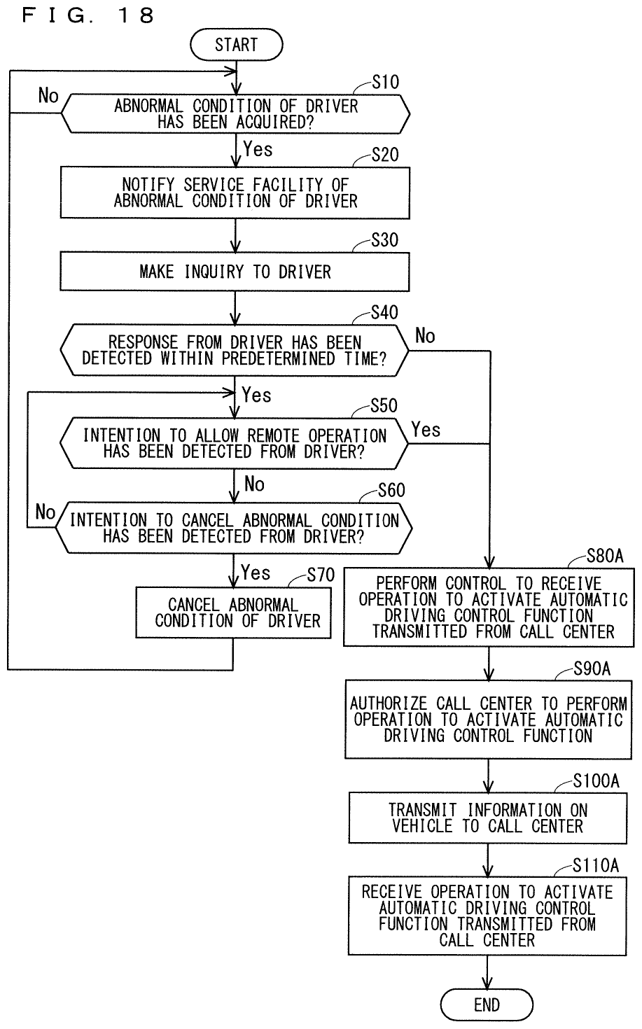

FIG. 17 is a block diagram showing configurations of a driver abnormality response device 105 and a driver abnormality response system 205 in Embodiment 4. The driver abnormality response system 205 includes an automatic driving controller 190 in place of the remote driving interface 150 in Embodiment 2.

The automatic driving controller 190 controls the driving control device 170 so that the vehicle travels to the destination automatically. In other words, the automatic driving control function of the vehicle is achieved by the automatic driving controller 190.

The surroundings information detection device 160 detects surroundings information of the vehicle required for the vehicle to travel through automatic driving control. The surroundings information detection device 160 is a camera, an image recognition device, laser radar, an ultrasonic sensor, millimeter wave radar, or the like.

The controller 20 performs the intention check sequence based on the abnormal condition of the driver acquired by the driver abnormality acquisition unit 10. The controller 20 checks whether the driver has an intention to allow the call center 211 to perform the remote operation on the control of driving of the vehicle in the intention check sequence. The remote operation on the control of driving of the vehicle in Embodiment 4 is operation to remotely activate the automatic driving control function of the vehicle. In this case, the controller 20 provides the driver with a notification to check the intention, and detects a response to the notification from the driver via the call controller 60.

Based on the result of the intention check sequence, the controller 20 authorizes the call center 211 to perform the operation to remotely activate the automatic driving control function via the communication network 220. The function of the controller 20 is achieved by the processing circuit shown in FIG. 2 or 3.

Based on the abnormal condition of the driver, the call center 211 calls the driver to request rescue by the medical facility 3 or the emergency moving body. The emergency moving body is herein the emergency vehicle 2. The call center 211 is authorized by the driver abnormality response device 105 to perform the operation to remotely activate the automatic driving control function of the vehicle. The call center 211 remotely activates the automatic driving control function of the vehicle via the communication network 220 by being authorized.

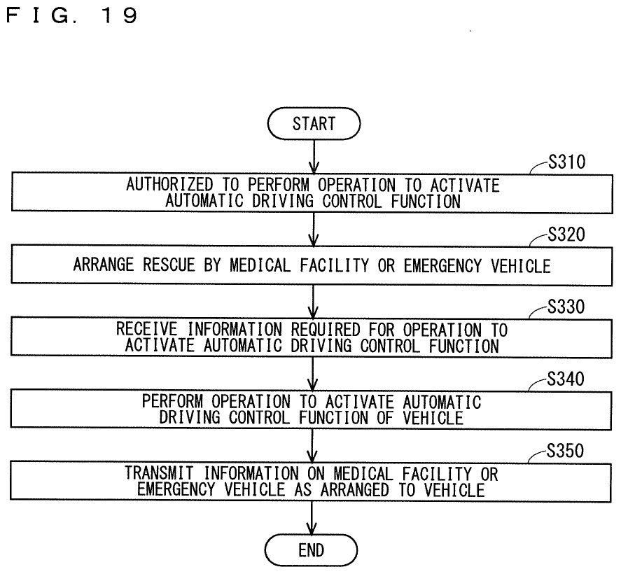

FIG. 18 is a flowchart showing operation of the driver abnormality response device 105 in the driver abnormality response method in Embodiment 4. Steps S10 to S70 are similar to those in Embodiment 2.

In step 580A, the controller 20 controls the automatic driving controller 190 so that the automatic driving controller 190 receives the operation to activate the automatic driving control function transmitted from the call center 211.

In step S90A, the controller 20 authorizes the call center 211 to perform the operation to activate the automatic driving control function. The controller 20 also notifies the call center 211 of the determination to perform the first aid.

In step S100A, the controller 20 transmits, to the call center 211, the information on the vehicle required for the operation to activate the automatic driving control function.

In step S110A, the automatic driving controller 190 receives the operation to activate the automatic driving control function transmitted from the call center 211 to activate the automatic driving control function.

FIG. 19 is a flowchart showing operation of the service facility 210 in the driver abnormality response method in Embodiment 4.

In step S310, the call center 211 is authorized by the driver abnormality response device 105 to perform the operation to activate the automatic driving control function.

In step S320, based on the determination to perform the first aid notified by the driver abnormality response device 105, the call center 211 arranges rescue of the driver by the medical facility 3 or the emergency vehicle 2.

In step S330, the call center 211 receives the information on the vehicle required for the operation to activate the automatic driving control function transmitted from the driver abnormality response device 105.

In step S340, the call center 211 performs the operation to activate the automatic driving control function of the vehicle via the communication network 220. For example, the call center 211 transmits a signal to activate the automatic driving control function to the automatic driving controller 190 of the vehicle.

In step S350, the call center 211 transmits information on the medical facility 3 or the emergency vehicle 2 as arranged to the vehicle. The automatic driving controller 190 of the vehicle sets the destination of the vehicle based on the information, and controls the driving control device 170 so that the vehicle travels to the destination automatically.

The driver abnormality response method thus ends.

In summary, the remote operation on the control of driving of the vehicle in Embodiment 4 is the operation to remotely activate the automatic driving control function of the vehicle so that the vehicle travels automatically.

The driver abnormality response device 105 as described above can accurately determine whether to cause the service facility 210 to perform the operation to activate the automatic driving control function of the vehicle based on the intention of the driver. The driver abnormality response system 205 allows for movement of the vehicle to the medical facility 3 or the emergency vehicle 2 through autonomous automatic driving of the vehicle. As a result, the time from the occurrence of the abnormality of the driver to the start of the first aid is reduced.

The service facility 210 in Embodiment 4 includes the call center 211 to receive the abnormal condition of the driver acquired by the driver abnormality acquisition unit 10. The controller 20 starts the intention check sequence based on the communication from the call center 211 having received the abnormal condition of the driver. Based on the result of the intention check sequence, the controller 20 authorizes the call center 211.

The driver abnormality response device 105 as described above can accurately determine whether to cause the call center 211 to perform the operation to activate the automatic driving control function of the vehicle by cooperating with the call center 211.

(Modification of Embodiment 4)

The driver abnormality response device in a modification of Embodiment 4 has a function to switch between a remote automatic driving operation mode corresponding to the function of the driver abnormality response device 101 in Embodiment 2 and an automatic driving control mode corresponding to the function of the driver abnormality response device 105 shown in Embodiment 4. In the remote automatic driving operation mode, the controller 20 performs the intention check sequence to check whether the driver has the intention to allow the remote driving service center 212 to perform the remote automatic driving operation. In the automatic driving control mode, the controller 20 performs the intention check sequence to check whether the driver has the intention to allow the call center 211 to perform the remote operation on the control of driving of the vehicle.

For example, the controller 20 operates in the remote automatic driving operation mode in a road segment in which automatic driving is not possible. In this case, the driver abnormality response system performs the operation shown in Embodiment 2. On the other hand, the controller 20 operates in the automatic driving control mode in a road segment in which automatic driving is possible. In this case, the driver abnormality response system performs the operation shown in Embodiment 4.

The driver abnormality response device as described above expands a segment in which the vehicle can travel after the occurrence of the abnormality of the driver. The driver abnormality response device also reduces a load on the operator to perform the remote automatic driving operation.

The configurations shown in Embodiment 2, Embodiment 3, and the modifications thereof described above are applicable to the driver abnormality response device in Embodiment 4 and the modification thereof unless any contradictions occur.

### Embodiment 5

The driver abnormality response device shown in each of the above-mentioned embodiments is applicable to a system constructed by appropriately combining functions of a navigation device, a communication terminal, a server, and an application installed thereon. The navigation device herein includes a portable navigation device (PND), for example. The communication terminal includes a mobile terminal, such as a mobile phone, a smartphone, and a tablet, for example.

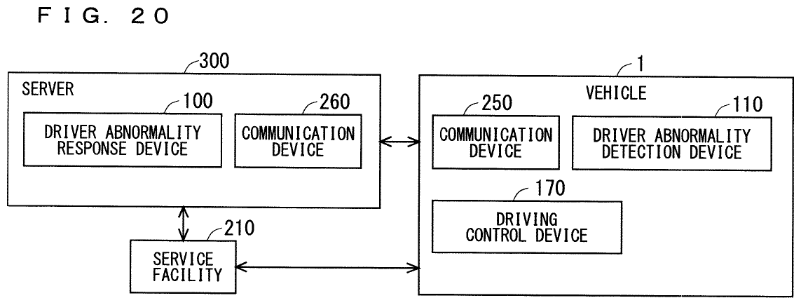

FIG. 20 is a block diagram showing configurations of the driver abnormality response device 100 in Embodiment 5 and devices operating in conjunction with the driver abnormality response device 100.

The driver abnormality response device 100 and a communication device 260 are provided in a server 300. The driver abnormality response device 100 acquires the abnormal condition of the driver from the driver abnormality detection device 110 provided in the vehicle via a communication device 250 and the communication device 260. Based on the result of the intention check sequence, the driver abnormality response device 100 authorizes the service facility 210 to perform the remote operation on the control of driving of the vehicle. The service facility 210 performs the remote operation on the control of driving of the vehicle.

By disposing the driver abnormality response device 100 in the server 300 as described above, the configuration of the on-vehicle device 230 shown in FIG. 5 and the like can be simplified, for example.

The function or the components of the driver abnormality response device 100 may be distributed, for example, by providing a part of the function or some of the components in the server 300, and providing the other part of the function or the other components in the vehicle.

Embodiments and modifications of the present invention can freely be combined with each other, and can be modified or omitted as appropriate within the scope of the invention.

While the present invention has been described in detail, the foregoing description is in all aspects illustrative and not restrictive. It is therefore understood that numerous modifications not having been described can be devised without departing from the scope of the present invention.

### EXPLANATION OF REFERENCE SIGNS

1 vehicle, 2 emergency vehicle, 3 medical facility, 10 driver abnormality acquisition unit, 20 controller, 30 map acquisition unit, 40 vehicle position acquisition unit, 50 communication unit, 60 call controller, 70 notification controller, 100 driver abnormality response device, 111 operation device, 112 driver monitoring device, 120 map storage device, 130 positioning device, 140 call device, 150 remote driving interface, 160 surroundings information detection device, 170 driving control device, 180 notification device, 190 automatic driving controller, 201 driver abnormality response system, 210 service facility, 211 call center, 212 remote driving service center, 220 communication network.

1-20. (canceled)

21. A driver abnormality response system comprising:
a service facility to perform remote operation on control of driving of a vehicle; and
a driver abnormality response device to authorize, based on an abnormal condition of a driver of the vehicle, the service facility to perform the remote operation, wherein
the driver abnormality response device includes:
driver abnormality acquiring circuitry to acquire the abnormal condition of the driver of the vehicle; and
controlling circuitry that performs, based on the abnormal condition of the driver, an intention check sequence to check whether the driver has an intention to allow the service facility to perform the remote operation, and authorizes, based on a result of the intention check sequence, the service facility to perform the remote operation,
the remote operation includes remote automatic driving operation to remotely drive the vehicle so that the vehicle travels automatically,
the remote automatic driving operation includes operation to cause the vehicle to arrive at one of a medical facility and an emergency moving body for rescue of the driver, and
based on a positional relationship among the vehicle, the medical facility and the emergency moving body, the service facility determines a target position for moving the vehicle.

22. The driver abnormality response system according to claim 21, wherein
the target position is determined based on a comparison between time required for the vehicle to arrive at the medical facility and time required for the emergency moving body to arrive at the medical facility after the vehicle meets the emergency moving body.

23. The driver abnormality response system according to claim 21, wherein
the target position is determined based on an emergency point of view on the abnormal condition of the driver in addition to the positional relationship.

24. The driver abnormality response system according to claim 21, wherein
the remote automatic driving operation includes operation to move the vehicle to stop the vehicle in an area suitable for rescue of the driver.

25. The driver abnormality response system according to claim 21, wherein
the remote automatic driving operation further includes environment control operation to control an environment equipment mounted on the vehicle, and
the environment equipment operation includes at least one of operation to control an air conditioning equipment of the vehicle, operation to control opening and closing of a window of the vehicle, and operation to control an angle of a seat of the vehicle.

26. The driver abnormality response system according to claim 21, wherein
the controlling circuitry transmits at least one of a video of the driver taken by a camera mounted on the vehicle, and physiological information of the driver sensed by physiological measurement sensor for sensing the physiological information of the driver to the service facility.

27. The driver abnormality response system according to claim 21, wherein
the remote operation further includes operation to remotely activate an automatic driving control function of the vehicle so that the vehicle travels automatically.

28. The driver abnormality response system according to claim 21, wherein
the controlling circuitry provides the driver with a notification to check whether the driver has the intention, and detects a response to the notification from the driver, thereby performing the intention check sequence, and
the result of the intention check sequence includes the response from the driver.

29. The driver abnormality response system according to claim 21, wherein
the service facility includes a call center to receive the abnormal condition of the driver acquired by the driver abnormality acquiring circuitry, and
the controlling circuitry starts the intention check sequence based on a communication from the call center having received the abnormal condition of the driver, and authorizes, based on the result of the intention check sequence, the call center.

30. The driver abnormality response system according to claim 21, wherein
the service facility includes:
a call center to receive the abnormal condition of the driver acquired by the driver abnormality acquiring circuitry; and
a remote driving service center capable of performing the remote automatic driving operation, and
the controlling circuitry starts the intention check sequence based on a communication from the call center having received the abnormal condition of the driver, and authorizes, based on the result of the intention check sequence, the remote driving service center via the call center.

31. The driver abnormality response system according to claim 21, wherein
the service facility includes:
a call center to receive the abnormal condition of the driver acquired by the driver abnormality acquiring circuitry; and
an emergency moving body heading for rescue of the driver and capable of performing the remote automatic driving operation, and
the controlling circuitry starts the intention check sequence based on a communication from the call center having received the abnormal condition of the driver, and authorizes, based on the result of the intention check sequence, the emergency moving body via the call center.

32. The driver abnormality response system according to claim 21, wherein
the controlling circuitry transmits identification information associated with the vehicle to the authorized service facility, and
the remote operation on the vehicle is performed based on a result of comparison between the identification information held by the service facility to perform the remote operation and the identification information associated with the vehicle.

33. A driver abnormality response device comprising:
driver abnormality acquiring circuitry to acquire an abnormal condition of a driver of a vehicle;
controlling circuitry that performs, based on the abnormal condition of the driver, an intention check sequence to check whether the driver has an intention to allow a service facility capable of performing remote operation on control of driving of the vehicle to perform the remote operation, and authorizes, based on a result of the intention check sequence, the service facility to perform the remote operation; and
notification controlling circuitry to perform control to cause a notification device provided in the vehicle to sequentially provide notifications that the intention check sequence has been started, that the service facility has been authorized, of a positional relationship among a medical facility and an emergency moving body arranged by the authorized service facility and the vehicle, and of time required for the vehicle to arrive at the medical facility or to meet the emergency moving body.

34. A driver abnormality response method comprising:
acquiring an abnormal condition of a driver of a vehicle;
performing, based on the abnormal condition of the driver, an intention check sequence to check whether the driver has an intention to allow a service facility capable of performing remote operation on control of driving of the vehicle to perform the remote operation, and authorizing, based on a result of the intention check sequence, the service facility to perform the remote operation; and
determining a target position for moving the vehicle, based on a positional relationship among the vehicle, a medical facility and an emergency moving body for rescue of the driver, wherein
the remote operation includes remote automatic driving operation to remotely drive the vehicle so that the vehicle travels automatically, and
the remote automatic driving operation includes operation to cause the vehicle to arrive at one of the medical facility and the emergency moving body.
